(19) United States
(12) Patent Application Publication
(10) Pub. No.: US 2025/0081992 A1
(43) Pub. Date: Mar. 13, 2025

(54) COMPREHENSIVE NUTRITIONAL PET FOOD

(71) Applicant: Unicharm Corporation, Ehime (JP)

(72) Inventors: Masataka Miyamoto, Itami-shi (JP); Waka Sawada, Itami-shi (JP); Yuma Ikezaki, Itami-shi (JP); Tomomi Kurata, Itami-shi (JP)

(73) Assignee: Unicharm Corporation, Ehime (JP)

(21) Appl. No.: 18/960,289

(22) Filed: Nov. 26, 2024

Related U.S. Application Data
(63) Continuation of application No. PCT/JP2023/019905, filed on May 29, 2023.

(30) Foreign Application Priority Data
May 30, 2022 (JP) 2022-088013

(51) Int. Cl. A23K 50/42; A23K 40/25

(52) U.S. Cl. CPC A23K 50/42; A23K 40/25

(57) ABSTRACT

A comprehensive nutritional pet food has a thickness greater than or equal to 5 and less than or equal to 8 mm, a ratio of the thickness to a minor axis (thickness:minor axis) greater than or equal to 1:1 and less than or equal to 1:2, and a hardness less than or equal to 70N.

### CROSS-REFERENCE TO RELATED APPLICATIONS

The present application is a bypass application of PCT Application No. PCT/JP2023/019905, filed on May 29, 2023, which claims priority to Japanese Patent Application No. 2022-088013, filed on May 30, 2022. The contents of these documents are incorporated by reference in their entirety.

### TECHNICAL FIELD

The present invention relates to a comprehensive nutritional pet food.

### BACKGROUND

When pet foods are classified according to the purpose of feeding and the occasion, pet foods can be classified into staple foods and in-between meal snacks. Pet food as a staple food is referred to as “comprehensive nutritional food” and is produced such that necessary nutrients can be taken in when this pet food and water are given.

On the other hand, an “in-between meal snack” is a pet food that is intended to be given in a limited amount in a case of pet training and exercise, or as a reward.

As classification according to the purposes, pet foods can be categorized into a “comprehensive nutritional food,” “in-between meal snacks,” “therapy diet,” and a “food for other purposes” that does not fall under any of them.

In addition, as classification according to moisture contents, pet foods are roughly classified into a dry food with a moisture content of about 10%, a soft food with a moisture content of about 15% to 35%, and a wet food with a moisture content of about 80%. Among these, a demand for dry type pet foods has been increasing in recent years from the viewpoints of ease of handling, good storage properties, and the like.

In recent years, particularly in pet foods for dogs and cats, a pet food having a small outer diameter and a small thickness has become the mainstream from the viewpoint of enhancing palatability. A pet food having a small outer diameter and thickness is considered to be highly palatable due to ease of eating. However, when the outer diameter and thickness of the pet food are small, a pet swallows the pet food whole without chewing, and there are health concerns such as overeating and choking.

As a method of preventing a pet from eating fast, Patent Literature 1 discloses a feeding bowl for pets having a lid in consideration of preventing a pet from eating fast and preventing obesity.

### CITATION LIST

### Patent Literature

Patent Literature 1: Japanese Unexamined Patent Publication No. 2020-130158

Like the feeding bowl for pets disclosed in Patent Literature 1, there is a feeding bowl for preventing a pet from eating fast, but a pet food capable of preventing a pet from eating fast has not been developed.

### SUMMARY

One or more embodiments of the present invention provide a comprehensive nutritional pet food capable of inducing a pet to chew and eat the comprehensive nutritional pet food and preventing fast eating.

The present inventors have conducted intensive studies on the size and hardness of a comprehensive nutritional pet food. As a result, it has been found that setting a thickness and a ratio of the thickness to a minor axis of the comprehensive nutritional pet food within specific ranges and softening the comprehensive nutritional pet food can induce pets to chew and eat the pet food. More specifically, the present invention employs the following.

One or more embodiments of the present invention have the following aspects.

[1] A comprehensive nutritional pet food having a thickness of 5 to 8 mm, a ratio of the thickness to a minor axis (thickness:minor axis) of 1:1 to 1:2, and a hardness of 70 N or less.

[2] The comprehensive nutritional pet food according to [1], wherein the thickness is smaller at a central portion than at an outer end portion.

[3] The comprehensive nutritional pet food according to [1] or [2], wherein the comprehensive nutritional pet food has a recessed portion in a thickness direction.

[4] The comprehensive nutritional pet food according to [3], wherein the comprehensive nutritional pet food has a through hole that penetrates the pet food in the thickness direction.

[5] The comprehensive nutritional pet food according to any one of [1] to [4], wherein the comprehensive nutritional pet food has a weight of 0.1 g or more and 0.6 g or less.

[6] The comprehensive nutritional pet food according to any one of [1] to [5], wherein a breaking strength in a maximum thickness direction is smaller than a breaking strength in a minimum thickness direction.

[7] The comprehensive nutritional pet food according to any one of [1] to [6], wherein the comprehensive nutritional pet food is a comprehensive nutritional pet food for cats.

According to one or more embodiments of the present invention, a comprehensive nutritional pet food capable of inducing a pet to chew and eat the comprehensive nutritional pet food and preventing fast eating can be provided.

### BRIEF DESCRIPTION OF DRAWINGS

FIG. 1 is a schematic view showing a pet food according to one or more embodiments of the present invention.

FIG. 2A is a plan view of the pet food according to one or more embodiments of the present invention.

FIG. 2B is a cross-sectional view of the pet food according to one or more embodiments of the present invention taken along a line IIB-IIB.

FIG. 3 is a schematic view showing a pet food according to one or more embodiments of the present invention.

FIG. 4 is a schematic view showing a method of producing the pet food according to one or more embodiments of the present invention.

### DETAILED DESCRIPTION

In the present description, the term “pet” refers to an animal raised by a human. In a narrower sense, a pet is an animal that is cherished by its owner. Furthermore, the “pet food” means feed for pets. The pet food according to the present invention can be sold as “animal fodder” or “animal feed”.

“Comprehensive nutritional food” is intended to be fed to a dog or a cat as a main meal for every day, out of pet food, and is a nutritionally balanced product capable of maintaining health at a specified growth stage only by the pet food and water. As a standard of the comprehensive nutritional food, for example, a standard defined by Association of American Feed Control Officials (AAFCO) can be used. It should be noted that, in the present description, the “comprehensive nutritional food” may be a food satisfying a standard of any stage of “puppy or kitten phase/growth phase or growth”, “fully-grown dog or cat phase/maintenance phase or maintenance”, and “pregnancy phase and lactation phase”, regardless of a growth stage, and may also be used for “all growth stages” or “all stages” that satisfy all three stages.

In the present description, the “palatability” is an index of whether a pet likes to eat, and is attributed to texture, taste, smell, and the like.

In the present description, a value of a moisture content is a value obtained by an atmospheric heating and drying method.

In the atmospheric heating and drying method, a subject to be measured is pulverized in a pulverizer by passing the subject through a 1 mm sieve. Then the pulverized subject is used as an analysis sample, and 2 to 5 g of the analysis sample is accurately weighed and placed in an aluminum weighing dish. After the analysis sample is dried at 135° C. for 2 hours and cooled in a desiccator, a weight of the analysis sample is accurately weighed again, so that moisture content is obtained from the weight difference in the analytical sample before and after drying.

More specifically, the subject to be measured is pulverized by a pulverizer such that the subject passes through a 1 mm sieve, and this pulverized product is used as an analysis sample. A mass (W1 gram) of an aluminum weighing can is measured in advance as a constant value. The analysis sample is placed in this aluminum weighing can, and a mass (W2 gram) is weighed. The analysis sample is then dried at 135° C. for 2 hours using a forced circulation type hot air dryer. After allowing the analysis sample to cool in a dry atmosphere (in a silica gel desiccator), a mass (W3 gram) is weighed. From each mass obtained, a moisture content of the analysis sample is obtained using the following formula. Moisture content (unit: mass %) of analysis sample=(W2−W3)/(W2−W1)×100

The moisture content is a value measured immediately after opening a final product within 30 days from a date of production or a value measured under the same conditions as above.

### Comprehensive Nutritional Pet Food

The comprehensive nutritional pet food according to one or more embodiments is a comprehensive nutritional pet food that satisfies the nutritional food standard for a dog or a cat, or may be a comprehensive nutritional cat food that satisfies the nutritional food standard for a cat.

That is, when the comprehensive nutritional pet food according to one or more embodiments has a thickness and a ratio of the thickness to a minor axis within specific ranges which will be described later, and is a comprehensive nutritional cat food that is not too hard, a cat can be induced to chew and eat the comprehensive nutritional pet food, and fast eating can be prevented.

In the present description, the “comprehensive nutritional pet food” does not mean one food granule, but a collection of multiple food granules.

Each parameter (thickness, minor axis, hardness, and the like) of the comprehensive nutritional pet food according to one or more embodiments means not a value of one granule of the comprehensive nutritional pet food but an average value of values of any ten granules taken among multiple comprehensive nutritional pet foods produced using the same ingredients and under the same conditions.

More specifically, each parameter means an average value of values of any ten granules taken out among multiple comprehensive nutritional pet foods included in a packaged dry type comprehensive nutritional pet food product.

Therefore, in a case where the average value satisfies each parameter, the entire comprehensive nutritional pet food product becomes the comprehensive nutritional pet food according to one or more embodiments.

The comprehensive nutritional pet food according to one or more embodiments may be a dry food, a soft food, or a wet food.

In the comprehensive nutritional pet food according to one or more embodiments, the moisture content may be 3 to 12 mass %, or may be 3 to 10 mass %.

The comprehensive nutritional pet food according to one or more embodiments has a thickness of 5 mm or more and 8 mm or less, or a thickness of more than 5 mm and 8 mm or less, or a thickness of 5.2 mm or more and 7 mm or less, and or a thickness of 5.2 mm or more and 6 mm or less.

In the comprehensive nutritional pet food according to one or more embodiments, a ratio of the thickness to the minor axis (thickness:minor axis) is 1:1 to 1:2, or 1:1.1 to 1:1.9, or 1:1.5 to 1:1.9.

In the present description, the “minor axis” means the minor axis or diameter of a surface with the maximum area in the comprehensive nutritional pet food according to one or more embodiments. The minor axis or diameter of the surface with the maximum area can be measured with a caliper. The maximum area of the surface can be calculated from the values of the major axis and the diameter measured with the caliper.

It should be noted that in a case where the surface with the maximum area in the comprehensive nutritional pet food according to one or more embodiments is a curved surface, the “surface with the maximum area” means the major axis or diameter of a projection surface obtained by projecting the curved surface using a microscope.

Specifically, the comprehensive nutritional pet food according to one or more embodiments is placed on a measuring table so that a surface having the maximum area in a plan view becomes the top surface (the surface to be imaged), an image of the top surface of the pet food is imaged using a digital microscope (trade name “VHX-7000”, manufactured by Keyence Corporation), and measurement can be performed using the image with a measurement and scale tool of the digital microscope.

In the present description, the “thickness” means the maximum height when the surface with the maximum area in the comprehensive nutritional pet food according to one or more embodiments is the bottom face.

The maximum height of the comprehensive nutritional pet food according to one or more embodiments can be measured with a caliper.

The comprehensive nutritional pet food according to one or more embodiments has a hardness of 70 N or less, or 60 N or less, or 55 N or less, or 50 N or less.

The lower limit value of the hardness of the comprehensive nutritional pet food according to one or more embodiments is not particularly limited, and is, for example, 10 N or more.

The hardness of the comprehensive nutritional pet food means the hardness of the central portion of the surface with the maximum area.

The hardness of the comprehensive nutritional pet food according to one or more embodiments can be measured by the following method.

A breaking force when the comprehensive nutritional pet food is compressed at a constant compression rate is measured under the following conditions using a compression tester (texture analyzer, model No: EZ-SX, manufactured by Shimadzu Corporation).

Plunger: plunger having a diameter of 10 mm and a canine tooth-like conical leading end, Platform: flat pan (diameter: about 117 mm), Compression rate: 60 mm/min, Lowest point of plunger: 2.5 mm (compression distance), Measurement temperature: 25° C.

Specifically, one granule of the comprehensive nutritional pet food to be measured is placed on the pan, and a test force is measured while the plunger is vertically pressed from directly above the granule at a constant rate. A peak value (maximum value) of the test force is read as the value of the breaking force. When the comprehensive nutritional pet food is broken during the measurement, the measurement of the comprehensive nutritional pet food is finished at that point.

The unit is converted to Newtons (N) by multiplying the numerical value of the breaking force (unit: kgw) measured by the compression tester by 9.8.

In one or more embodiments, the thickness of the comprehensive nutritional pet food is smaller at the central portion than in the outer end portion.

Reducing the thickness of the portion with which the teeth come into contact during chewing while keeping the outer shape large makes it easier to chew the pet food, so that it is possible to further induce a pet to chew and eat the comprehensive nutritional pet food of one or more embodiments and to further prevent fast eating.

The central portion of the comprehensive nutritional pet food according to one or more embodiments may have a thickness of 95% or less, or a thickness of 90% or less, or a thickness of 85% or less, with respect to 100% of the thickness of the outer end portion of the pet food.

When the thickness of the central portion of the comprehensive nutritional pet food according to one or more embodiments is the above-mentioned value or less with respect to the thickness of the outer end portion, a pet can be further induced to chew and eat the comprehensive nutritional pet food of one or more embodiments and fast eating can be further prevented.

The comprehensive nutritional pet food according to one or more embodiments has a recessed portion. By providing the recessed portion that allows easy insertion of teeth while keeping the outer shape large, a pet can be induced to chew and eat the comprehensive nutritional pet food of one or more embodiments without losing interest and fast eating can be further prevented.

The comprehensive nutritional pet food according to one or more embodiments may have one recessed portion or multiple recessed portions, or may have multiple recessed portions.

In a case where the comprehensive nutritional pet food according to one or more embodiments has multiple recessed portions, a distance between the recessed portions may be 1.5 to 3 mm, or may be 1.5 to 2.5 mm.

The comprehensive nutritional pet food according to one or more embodiments has a through hole that penetrates the pet food in a thickness direction.

By providing the through hole that allows easy insertion of teeth while keeping the outer shape large, a pet can be induced to chew and eat the comprehensive nutritional pet food of one or more embodiments without losing interest and fast eating can be further prevented.

The comprehensive nutritional pet food according to one or more embodiments may have one through hole or multiple through holes, or may have multiple through holes. Specifically, the comprehensive nutritional pet food according to one or more embodiments may have 2 to 6 through holes, or 3 to 5 through holes, or 4 through holes.

In a case where the comprehensive nutritional pet food according to one or more embodiments has multiple through holes, the size and shape of the through holes may be the same as or different from each other.

In a case where the comprehensive nutritional pet food according to one or more embodiments has the through hole, the major axis or diameter of the through hole may be 1 mm or more and 4 mm or less, or 1.3 mm or more and 3.5 mm or less, or 1.5 mm or more and 2.5 mm or less.

The major axis or diameter of the through hole can be measured with a caliper.

In a case where the comprehensive nutritional pet food according to one or more embodiments has the multiple through holes, a distance between the through holes may be 1.5 to 3 mm, or 1.5 to 2.5 mm.

The cross-sectional shape of the through hole of the comprehensive nutritional pet food according to one or more embodiments may be a circular shape, an elliptical shape, and a polygonal shape (for example, a triangle, a square, a pentagon, a hexagon, a rhombus, and a trapezoid).

The comprehensive nutritional pet food according to one or more embodiments is a comprehensive nutritional pet in which the thickness is 5 mm or more and 8 mm or less, or more than 5 mm and 8 mm or less, or 5.2 mm or more and 7 mm or less, or 5.2 mm or more and 6 mm or less,
a ratio of the thickness to the major axis (thickness:major axis) is 1:1 to 1:2, or 1:1.1 to 1:1.9, or 1:5 to 1:7,
the hardness is 70 N or less, or 60 N or less, or 55 N or less, or 50 N or less,
the thickness may be reduced from the outer end portion toward the central portion,
the central portion of the pet food may have a thickness of 95% or less, or a thickness of 90% or less, or a thickness of 85% or less, with respect to 100% of the thickness of the outer end portion of the pet food, and
the pet food has multiple recessed portions (may be through holes).

It is preferable that the comprehensive nutritional pet food according to one or more embodiments has a weight of 0.1 g or more and 0.6 g or less.

The weight of the comprehensive nutritional pet food according to one or more embodiments can be measured, for example, using an electronic balance (trade name “Analytical Balance (sefi) IUW-200D”, manufactured by As One Corporation).

The shape of the comprehensive nutritional pet food according to one or more embodiments is not particularly limited as long as it has a shape suitable for a pet to eat.

For example, any shape such as a spherical, ellipsoidal (go stone-like), pellet, cylindrical, polygonal columnar, hexahedral (plate-like), clover, heart, star, or cruciform shape is applicable. Of these, a cylindrical shape may be used to more easily obtaining the effect of the present invention.

It is preferable that in the comprehensive nutritional pet food according to one or more embodiments, the breaking strength in the maximum thickness direction is smaller than the breaking strength in the minimum thickness direction. More specifically, for example, in the comprehensive nutritional pet food according to one or more embodiments, the breaking strength of the outer end portion having the maximum thickness is smaller than the breaking strength of the central portion having the minimum thickness.

Since the above-described comprehensive nutritional pet food is easily chewed even in a case of chewing the pet food in a direction in which the pet food is less likely to be chewed, a pet can be further induced to chew and eat the comprehensive nutritional pet food of one or more embodiments and fast eating can be further prevented.

As for a method of measuring the breaking strength in the maximum thickness direction and the breaking strength in the minimum thickness direction of the comprehensive nutritional pet food according to one or more embodiments, the breaking strength can be measured in the same method as in the “hardness of the comprehensive nutritional pet food” described above by changing the position where leading end of the conical plunger comes into contact with the comprehensive nutritional pet food.

### <<Ingredients>>

As the ingredient of the comprehensive nutritional pet food according to one or more embodiments, well-known powder ingredients and liquid ingredients can be used in the production of the pet food. Specific examples of powder ingredients include cereals (corn, wheat, wheat flour, wheat bran, rice, bread crumbs, barley, oat, rye, and the like), potatoes (sweet potatoes, potatoes, and the like), beans (whole soybeans and the like), starches (wheat starch, corn starch, rice starch, potato starch, tapioca starch, sweet potato starch, sago starch, modified starch, and the like), vegetable proteins (corn gluten meal, wheat protein, bean protein, rice protein, potato protein, and the like), meat (meat of domesticated or wild animals such as cows, pigs, sheep, deer, and rabbits; meat of fowl such as chickens, turkeys, quails, and domestic poultry; meal (chicken meal, pork meal, beef meal, mixed meal of these); and the like), fishes and shellfishes (fishes such as tuna, bonito, and horse mackerel; crustaceans such as shrimp and crab; mollusks such as octopus and squid; shellfishes such as scallops and turban shells; fish extracts; Katsuobushi (dried bonito flakes); meal (fish meal); and the like), vegetables, nuts and seeds, mushrooms, eggs, sugars, milk, additives (vitamins, minerals, amino acids, flavoring ingredients, powdery palatability enhancers, fibers, colorants, phosphates, pH adjusters, seasonings, antioxidants, trehalose, and the like), and the like.

Meal means a powder obtained by compressing and finely grinding meat or fishes and shellfishes. More specific examples of powdery palatability enhancers include animal ingredient extracts, plant ingredient extracts, yeast extracts, dried products of yeast, and the like.

Specific examples of liquid ingredients (including semi-solid ingredients) include water, oils and fats (animal oils and fats such as chicken fat (chicken oil), pork fat (lard), beef fat (tallow), milk fat, and fish oil; and vegetable oils and fats such as olive oil, cacao oil, palm oil, palm kernel oil, coconut oil, coconut oil, and camellia oil), liquid palatability enhancers, liquid sugars, moisturizers, preservatives, emulsifiers, fragrances, colorants, and the like.

A formulation example of the comprehensive nutritional pet food (dry type) according to one or more embodiments is shown below.

Cereals: 20% to 60%, meat: 10% to 40%, fishes and shellfishes: 1% to 10%, fibers: 1% to 10%, vitamins, minerals, and amino acids: 1% to 5%, and animal oils and fats: 1% to 10% (total of these is 100%).

Hereinafter, as specific aspects of the comprehensive nutritional pet food according to one or more embodiments, comprehensive nutritional pet foods according to one or more embodiments will be described in detail with reference to the drawings.

### Comprehensive Nutritional Pet Food According to One or More Embodiments of Present Invention

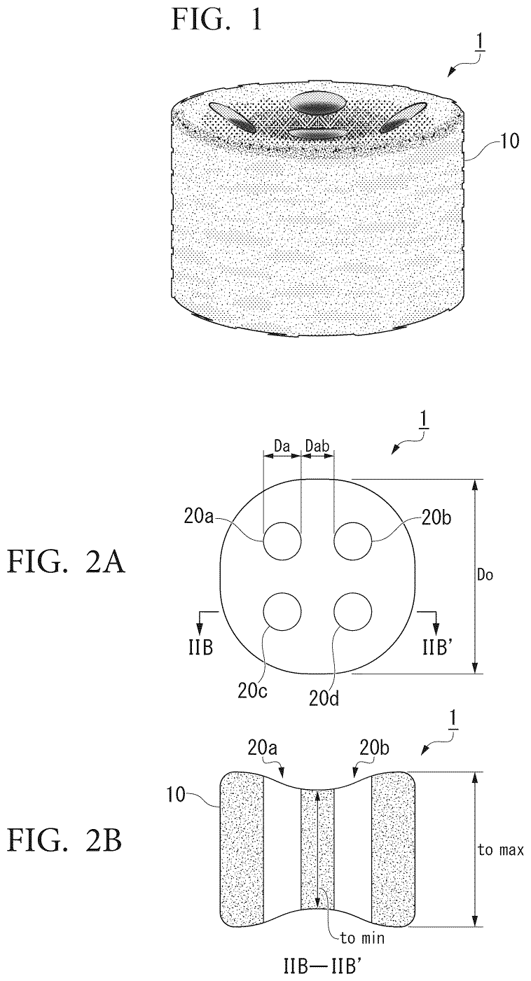

A comprehensive nutritional pet food 1 according to one or more embodiments of the present invention will be described in detail with reference to FIGS. 1 and 2A-2B. As shown in FIGS. 1 and 2A-2B, in the comprehensive nutritional pet food 1, four through holes 20a to 20d are formed in a cylindrical base substance 10. The comprehensive nutritional pet food 1 is a dry type pet food.

In the comprehensive nutritional pet food 1, a maximum thickness tₒmax is 5 to 8 mm, a ratio of the maximum thickness tₒmax to a major axis D₀ (tₒmax:D₀) is 1:1 to 1:2, and the hardness is 70 N or less.

The comprehensive nutritional pet food 1 is a comprehensive nutritional pet food having a maximum thickness tₒmax of 5 to 8 mm and a relatively thick. However, since the comprehensive nutritional pet food 1 has the four through holes 20a to 20d, the comprehensive nutritional pet food 1 is a pet food that has a hardness of 70 N or less and is relatively not too hard.

The maximum thickness tₒmax is 5 mm or more and 8 mm or less, or more than 5 mm and 8 mm or less, or 5.2 mm or more and 7 mm or less, or 5.2 mm or more and 6 mm or less.

The ratio of the maximum thickness tₒmax to the major axis D₀ (tₒmax:D₀) is 1:1 to 1:2, or from 1:1.1 to 1:1.9, or from 1:1.5 to 1:1.7.

The hardness of the comprehensive nutritional pet food 1 is 70 N or less, or 60 N or less, or 55 N or less, or 50 N or less.

As shown in FIGS. 1 and 2B, the comprehensive nutritional pet food 1 has a thickness that decreases from an outer end portion toward a central portion.

A minimum thickness tₒmin may be a thickness of 95% or less, or a thickness of 90% or less, or a thickness of 85% or less, with respect to 100% of the maximum thickness tₒmax.

A distance Dab between the through hole 20a and the through hole 20b may be 1.5 to 3 mm, or 1.5 to 2.5 mm.

In one or more embodiments, the distance between the through hole 20a and the through hole 20c and the distance between the through hole 20c and the through hole 20d are the same as the distance Dab.

The cross-sectional shape of each of the through holes 20a to 20d has a circular shape, but may be an elliptical shape and a polygonal shape (for example, a triangle, a square, a pentagon, a hexagon, a rhombus, and a trapezoid).

The comprehensive nutritional pet food 1 has the four through holes 20a to 20d, but the number, size, and shape of the through holes are not limited as long as the hardness can be set to 70 N or less. Further, as long as the hardness can be set to 70 N or less, the through hole may be a recessed portion that does not penetrate the comprehensive nutritional pet food 1.

In one or more embodiments, the comprehensive nutritional pet food 1 has a weight of 0.1 g or more and 0.6 g or less.

### Comprehensive Nutritional Pet Food According to One or More Embodiments of Present Invention

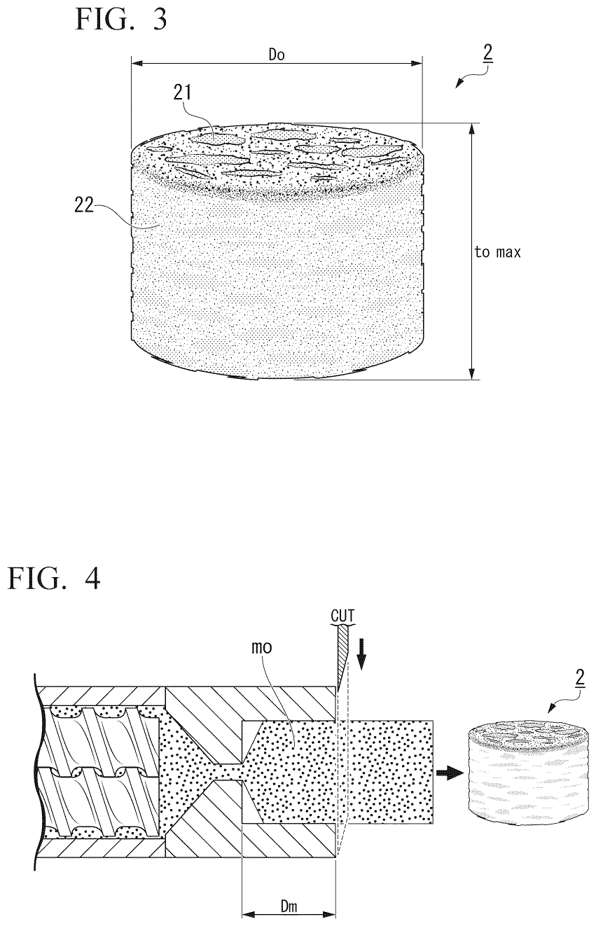

A comprehensive nutritional pet food 2 according to one or more embodiments of the present invention will be described in detail with reference to FIGS. 3 and 4.

As shown in FIG. 3, the comprehensive nutritional pet food 2 has multiple recessed portions 21 in a cylindrical base substance 22. The recessed portions 21 are typically traces of air bubbles generated by high puffing. The comprehensive nutritional pet food 2 is a dry type pet food.

In the comprehensive nutritional pet food 2, the maximum thickness tₒmax is 5 to 8 mm, the ratio of the maximum thickness tₒmax to the major axis D₀ (tₒmax:D₀) is 1:1 to 1:2, and the hardness is 70 N or less.

The comprehensive nutritional pet food 2 has a maximum thickness tₒmax of 5 to 8 mm and is a relatively thick comprehensive nutritional pet food. However, since the comprehensive nutritional pet food 2 has the multiple recessed portions 21, the comprehensive nutritional pet food 2 is a pet food that has a hardness of 70 N or less and is relatively not too hard.

The maximum thickness tₒmax may be 5 mm or more and 8 mm or less, or more than 5 mm and 8 mm or less, or 5.2 mm or more and 7 mm or less, or 5.2 mm or more and 6 mm or less.

The ratio of the maximum thickness tₒmax to the major axis D₀ (tₒmax:D₀) may be 1:1 to 1:2, or from 1:1.1 to 1:1.9, or from 1:1.5 to 1:1.7.

The hardness of the comprehensive nutritional pet food 2 may be 70 N or less, or 60 N or less, or 55 N or less, or 50 N or less.

In one or more embodiments, the comprehensive nutritional pet food 2 has a weight of 0.1 g or more and 0.6 g or less.

The comprehensive nutritional pet food 2 has the multiple recessed portions 21, but the number, size, and shape of the recessed portions 21 are not limited as long as the hardness can be set to 70 N or less. The number, size, and shape of the recessed portions 21 can be controlled by adjusting the method of producing the comprehensive nutritional pet food 2.

FIG. 4 is a schematic view of a method of producing the comprehensive nutritional pet food 2.

A dry type comprehensive nutritional pet food is generally produced by extruding and forming an ingredient mixture using an extruder and puffing the ingredient mixture.

As a method of producing a dry type comprehensive nutritional pet food using an extruder, for example, a method described in “Small Animal Clinical Nutrition, 5th Edition” (edited by Michael S. Hand, Craig D. Thatcher, Rebecca L. Remillard, Philip Roudebusg, and Bruce J. Novotny; published by Mark Morris Associates; 2014; p. 209 to p. 215) can be applied.

In a dry type comprehensive nutritional pet food of the related art, an ingredient mixture is put into an extruder, heated, pressurized, and then extruded from an outlet. At the outlet, a plate in which a hole having a predetermined shape is formed, and a cutter that cuts the ingredient mixture extruded from the plate to have a predetermined length (thickness) are provided. While the ingredient mixture is extruded from the hole of the plate and cut by the cutter to be formed in a predetermined shape, the ingredient mixture is released from a pressurized state to an atmospheric pressure to expand the water vapor in the ingredient mixture. Thus, the ingredient mixture is puffed to obtain a dry type comprehensive nutritional pet food. In the dry type comprehensive nutritional pet food produced by such a production method of the related art, when the thickness is set to 5 to 8 mm and the ratio of the thickness to the major axis (thickness:major axis) is set to 1:1 to 1:2, the dry type comprehensive nutritional pet food becomes a hard comprehensive nutritional pet food having a hardness of more than 70N.

As shown in FIG. 4, in the method of producing the comprehensive nutritional pet food 2, the ingredient mixture extruded from the hole of the plate is not immediately cut by the cutter, and is cut by the cutter after the ingredient mixture is highly puffed in a puffing space m0. Therefore, since the comprehensive nutritional pet food 2 becomes a highly puffed pet food and has a large amount of voids, the pet food is relatively not too hard compared to the pet food having the same shape produced by the production method of the related art.

### EXAMPLES

Hereinafter, embodiments of the present invention will be further described in detail using examples, but the present invention is not limited to these examples.

### Production of Comprehensive Nutritional Pet Food

Ingredients for granules constituting the granular pet food were mixed in a formulation shown in Table 1. The obtained ingredient mixture was put into an extruder, subjected to a heat treatment while being kneaded so that a starch component was gelatinized, and then extruded and granulated into a granular shape at an outlet of the extruder and puffed at the same time. The obtained granules were subjected to a drying treatment using a dryer to produce a comprehensive nutritional pet food of Example having four through holes and having the same shape as the comprehensive nutritional pet food shown in FIG. 1.

TABLE 1

| | Mass % |
|---|---|
| Cereals | 47.0% |
| Meat | 31.0% |
| Fishes and shellfishes | 7.2% |
| Fibers | 8.0% |
| Vitamins, minerals, and amino acids | 1.8% |
| Animal oils and fats | 5.0% |
| Total | 100% |

### [Measurement of Major Axis, Minor Axis, and Thickness]

Ten granules of the comprehensive nutritional pet food of Example produced by the above method were prepared (comprehensive nutritional pet foods of Examples 1a to 1j), and the major axis, minor axis, and thickness were respectively measured with a caliper. The results are shown in Table 2. In addition, as described above, the major axis, minor axis and thickness of ten granules of a comprehensive nutritional pet food of Commercial product A and ten granules of a comprehensive nutritional pet food of Commercial product B were measured with a caliper. The results are shown in Tables 3 and 4.

TABLE 2

| | Major axis | Minor axis | Thickness | Thickness:Minor |
|---|---|---|---|---|
| | (mm) | (mm) | (mm) | axis |
| Example 1a | 11.91 | 10.56 | 5.86 | (1:1.8) |
| Example 1b | 10.79 | 10.02 | 5.11 | (1:1.96) |
| Example 1c | 12.02 | 9.95 | 5.37 | (1:1.85) |
| Example 1d | 11.09 | 10.14 | 5.46 | (1:1.86) |
| Example 1e | 11.61 | 9.83 | 5.09 | (1:1.93) |
| Example 1f | 11.08 | 10.37 | 5.47 | (1:1.90) |
| Example 1g | 11.10 | 10.03 | 5.36 | (1:1.87) |
| Example 1h | 11.53 | 9.99 | 5.59 | (1:1.78) |
| Example 1i | 11.53 | 10.27 | 5.35 | (1:1.92) |
| Example 1j | 11.38 | 9.87 | 5.03 | (1:1.96) |
| Average | 11.40 | 10.10 | 5.37 | (1:1.88) |

TABLE 3

| | Major | Minor | | (Thick- |
|---|---|---|---|---|
| | axis | axis | Thickness | ness:Minor |
| | (mm) | (mm) | (mm) | axis) |
| Commercial product A1 | 11.08 | 10.92 | 6.92 | (1:1.58) |
| Commercial product A2 | 10.6 | 9.69 | 6.87 | (1:1.41) |
| Commercial product A3 | 11.13 | 10.43 | 7.24 | (1:1.44) |
| Commercial product A4 | 10.96 | 10.75 | 6.97 | (1:1.54) |
| Commercial product A5 | 11.68 | 10.89 | 7.23 | (1:1.51) |
| Commercial product A6 | 11.3 | 9.74 | 7.13 | (1:1.37) |
| Commercial product A7 | 11.37 | 9.79 | 7.37 | (1:1.33) |
| Commercial product A8 | 11.39 | 10.17 | 7.15 | (1:1.42) |
| Commercial product A9 | 10.93 | 10.27 | 6.98 | (1:1.47) |
| Commercial product A10 | 11.09 | 9.94 | 7.25 | (1:1.37) |
| Average | 11.15 | 10.26 | 7.11 | (1:1.44) |

TABLE 4

| | Major | Minor | | (Thick- |
|---|---|---|---|---|
| | axis | axis | Thickness | ness:Minor |
| | (mm) | (mm) | (mm) | axis) |
| Commercial product B1 | 11.07 | 9.94 | 4.87 | (1:2.00) |
| Commercial product B2 | 11 | 10.33 | 5.12 | (1:2.00) |
| Commercial product B3 | 11.48 | 9.93 | 4.49 | (1:2.21) |
| Commercial product B4 | 11.07 | 9.22 | 4.6 | (1:2.00) |
| Commercial product B5 | 11.5 | 9.89 | 4.65 | (1:1.93) |
| Commercial product B6 | 11.34 | 10.08 | 4.75 | (1:1.90) |
| Commercial product B7 | 11.38 | 9.79 | 4.91 | (1:1.87) |
| Commercial product B8 | 10.7 | 9.57 | 4.63 | (1:1.78) |
| Commercial product B9 | 10.46 | 9.58 | 4.41 | (1:1.92) |
| Commercial product B10 | 11.18 | 9.84 | 4.75 | (1:1.96) |
| Average | 11.12 | 9.82 | 4.72 | (1:2.08) |

### [Measurement of Hardness]

The hardness was measured by the following method for the comprehensive nutritional pet foods of Examples 1a to 1j, the comprehensive nutritional pet foods of Commercial products A1 to A10, and the comprehensive nutritional pet foods of Commercial products B1 to B10.

A breaking force when each comprehensive nutritional pet food was compressed at a constant compression rate was measured under the following conditions using a compression tester (texture analyzer, model No: EZ-SX, manufactured by Shimadzu Corporation).

Plunger: plunger having a diameter of 10 mm and a canine tooth-like conical leading end, Platform: flat pan (diameter: about 117 mm), Compression rate: 60 mm/min, Lowest point of plunger: 2.5 mm (compression distance), Measurement temperature: 25° C.

Specifically, one granule of the comprehensive nutritional pet food to be measured was placed on the pan, and the test force was measured while the plunger was vertically pressed from directly above the central portion of the surface (top surface) with the maximum area of the comprehensive nutritional pet food at a constant rate. A peak value (maximum value) of the test force was read as the value of the breaking force. When the comprehensive nutritional pet food was broken during the measurement, the measurement of the comprehensive nutritional pet food was finished at that point.

The unit was converted to Newtons (N) by multiplying the numerical value of the breaking force (unit: kgw) measured by the compression tester by 9.8.

The results are shown in Tables 5 to 7.

TABLE 5

| | Hardness |
|---|---|
| | (N) |
| Example 1a | 48.263 |
| Example 1b | 35.949 |
| Example 1c | 48.520 |
| Example 1d | 39.834 |
| Example 1e | 45.033 |
| Example 1f | 42.328 |
| Example 1g | 31.761 |
| Example 1h | 33.933 |
| Example 1i | 44.236 |
| Example 1j | 36.307 |
| Average | 40.62 |

TABLE 6

| | Hardness |
|---|---|
| | (N) |
| Commercial product A1 | 65.869 |
| Commercial product A2 | 75.194 |
| Commercial product A3 | 75.590 |
| Commercial product A4 | 90.954 |
| Commercial product A5 | 95.211 |
| Commercial product A6 | 52.400 |
| Commercial product A7 | 91.862 |
| Commercial product A8 | 67.756 |
| Commercial product A9 | 95.054 |
| Commercial product A10 | 78.464 |
| Average | 78.84 |

TABLE 7

| | Hardness |
|---|---|
| | (N) |
| Commercial product B1 | 86.863 |
| Commercial product B2 | 91.421 |
| Commercial product B3 | 79.710 |
| Commercial product B4 | 93.764 |
| Commercial product B5 | 83.057 |
| Commercial product B6 | 64.728 |
| Commercial product B7 | 83.791 |
| Commercial product B8 | 63.184 |
| Commercial product B9 | 74.632 |
| Commercial product B10 | 100.975 |
| Average | 82.21 |

As shown in Tables 2 to 4, the comprehensive nutritional pet food of Example, the comprehensive nutritional pet food of Commercial product A, and the comprehensive nutritional pet food of Commercial product B have similar thicknesses-to-minor axis ratios.

On the other hand, as shown in Tables 5 to 7, since the comprehensive nutritional pet food of Example had four through holes, it could be confirmed that the value (N) of the hardness was small compared with the comprehensive nutritional pet food of Commercial product A and the comprehensive nutritional pet food of Commercial product B, and the comprehensive nutritional pet food of Example was not too hard.

### [Measurement of Weight]

The weight of the comprehensive nutritional pet foods of Examples 1a to 1j was measured using an electronic balance (trade name “Analytical Balance (sefi) IUW-200D”, manufactured by As One Corporation). The results are shown in Table 8.

TABLE 8

| | Weight (g)/granule |
|---|---|
| Example 1a | 0.265 |
| Example 1b | 0.282 |
| Example 1c | 0.247 |
| Example 1d | 0.272 |
| Example 1e | 0.303 |
| Example 1f | 0.277 |
| Example 1g | 0.279 |
| Example 1h | 0.267 |
| Example 1i | 0.245 |
| Example 1j | 0.269 |
| Average | 0.271 |

### [Evaluation of Fast Eating Prevention Effect]

The comprehensive nutritional pet food of Example prepared by the method of “(Production of Comprehensive Nutritional Pet Food)” described above, and a comprehensive nutritional pet food of Commercial product C were fed to 24 cats (c-1 to c-24), and the time from the start of eating to finishing the meal was measured. In addition, the appearance of each cat eating the pet food was recorded on video, and the number of times of chewing was measured.

The comprehensive nutritional pet food of Commercial product C has a major axis of 7.5 mm, a minor axis of 7.0 mm, and a thickness of 3 mm.

The results are shown in Table 9.

TABLE 9

| | Example 1 | | | | | Commercial product C | | | | |
|---|---|---|---|---|---|---|---|---|---|---|
| | | | | Number | | | | | Number | |
| | | Meal | | of | | | Meal | | of | |
| | Food | finish | | times of | Chewing | Food | finish | | times of | Chewing |
| | intake | time | Pace | chewing | pace | intake | time | Pace | chewing | pace |
| cat No. | (g) | (sec) | (sec/g) | (times) | (times/g) | (g) | (sec) | (sec/g) | (times) | (times/g) |
| c-1 | 10.2 | 171 | 16.8 | 31 | 1.849122807 | 10.3 | 190 | 18.4 | 8 | 0.433684211 |
| c-2 | 10.1 | 150 | 14.9 | 35 | 2.356666667 | 10 | 144 | 14.4 | 6 | 0.416666667 |
| c-3 | 10.6 | 278 | 26.2 | 24 | 0.915107914 | 10 | 115 | 11.5 | 1 | 0.086956522 |
| c-4 | 10.5 | 89 | 8.5 | 22 | 2.595505618 | 10 | 88 | 8.8 | 6 | 0.681818182 |
| c-5 | 9.4 | 238 | 25.3 | 14 | 0.552941176 | 11 | 107 | 9.7 | 2 | 0.205607477 |
| c-6 | 11 | 95 | 8.6 | 23 | 2.663157895 | 10.5 | 91 | 8.7 | 1 | 0.115384615 |
| c-7 | 10.4 | 184 | 17.7 | 33 | 1.865217391 | 10.9 | 103 | 9.4 | 12 | 1.269902913 |
| c-8 | 10.2 | 174 | 17.1 | 32 | 1.875862069 | 10 | 170 | 17.0 | 4 | 0.235294118 |
| c-9 | 10.5 | 236 | 22.5 | 25 | 1.112288136 | 10 | 206 | 20.6 | 4 | 0.194174757 |
| c-10 | 11.7 | 96 | 8.2 | 7 | 0.853125 | 10 | 133 | 13.3 | 2 | 0.15037594 |
| c-11 | 10 | 159 | 15.9 | 12 | 0.754716981 | 9.9 | 112 | 11.3 | 1 | 0.088392857 |
| c-12 | 10 | 99 | 9.9 | 25 | 2.525252525 | 9.8 | 94 | 9.6 | 2 | 0.208510638 |
| c-13 | 10 | 200 | 20.0 | 33 | 1.65 | 11.1 | 90 | 8.1 | 12 | 1.48 |
| c-14 | 6.8 | 127 | 18.7 | 18 | 0.963779528 | 5.9 | 98 | 16.6 | 4 | 0.240816327 |
| c-15 | 10 | 199 | 19.9 | 30 | 1.507537688 | 10 | 170 | 17.0 | 7 | 0.411764706 |
| c-16 | 10 | 216 | 21.6 | 22 | 1.018518519 | 10.6 | 81 | 7.6 | 4 | 0.52345679 |
| c-17 | 7.1 | 105 | 14.8 | 24 | 1.622857143 | 10.3 | 78 | 7.6 | 4 | 0.528205128 |
| c-18 | 10.3 | 353 | 34.3 | 30 | 0.875354108 | 10.3 | 198 | 19.2 | 3 | 0.156060606 |
| c-19 | 11.2 | 110 | 9.8 | 30 | 3.054545455 | 10.3 | 88 | 8.5 | 9 | 1.053409091 |
| c-20 | 10.4 | 147 | 14.1 | 25 | 1.768707483 | 10.9 | 101 | 9.3 | 2 | 0.215841584 |
| c-21 | 10.4 | 128 | 12.3 | 25 | 2.03125 | 10.4 | 99 | 9.5 | 14 | 1.470707071 |
| c-22 | 10 | 133 | 13.3 | 31 | 2.330827068 | 10.4 | 113 | 10.9 | 25 | 2.300884956 |
| c-23 | 11.4 | 98 | 8.6 | 12 | 1.395918367 | 10.7 | 90 | 8.4 | 1 | 0.118888889 |
| c-24 | 10 | 275 | 27.5 | 23 | 0.836363636 | 9.7 | 192 | 19.8 | 9 | 0.4546875 |
| Average | 10.09 | 169.17 | 16.93 | 24.42 | 1.62 | 10.13 | 122.96 | 12.31 | 5.96 | 0.54 |

As shown in Table 9, since the pet food of Example 1 had a thickness of 5 to 8 mm, the ratio of the thickness to the minor axis (thickness:minor axis) was 1:1 to 1:2, and the hardness was 70N or less, it could be confirmed that the number of times of chewing could be increased and the eating pace could be decreased compared with the pet food of Commercial product C.

Although preferable examples of the present invention have been described above, the present invention is not limited to these examples. Configurations can be added, omitted, and replaced, and other modifications can be made within a range not departing from the spirit of the present invention. The present invention is not limited by the above descriptions, but only by the scope of the appended claims.

### REFERENCE SIGNS LIST

1, 2: comprehensive nutritional pet food
10, 22: base substance
20a, 20b, 20c, 20d: through hole
21: recessed portion

What is claimed is:

1. A comprehensive nutritional pet food, wherein
the pet food has
a thickness greater than or equal to 5 and less than or equal to 8 mm,
a ratio of the thickness to a minor axis (thickness:minor axis) greater than or equal to 1:1 and less than or equal to 1:2, and
a hardness less than or equal to 70N.

2. The comprehensive nutritional pet food according to claim 1, wherein
the thickness of the pet food is smaller at a central portion of the pet food than at an outer end portion of the pet food.

3. The comprehensive nutritional pet food according to claim 1, wherein
the pet food has a recessed portion in a thickness direction.

4. The comprehensive nutritional pet food according to claim 3, wherein
the pet food has a through hole that penetrates the pet food in the thickness direction.

5. The comprehensive nutritional pet food according to claim 1, wherein
the pet food has a weight greater than or equal to 0.1 g and less than or equal to 0.6 g.

6. The comprehensive nutritional pet food according to claim 1, wherein
a breaking strength in a maximum thickness direction of the pet food is smaller than a breaking strength in a minimum thickness direction of the pet food.

7. The comprehensive nutritional pet food according to claim 1, wherein
the pet food is a comprehensive nutritional pet food for cats.
